(19) United States
(12) Patent Application Publication
(10) Pub. No.: US 2006/0086815 A1
(43) Pub. Date: Apr. 27, 2006

(54) Device and method for heat test

(76) Inventor: Chun-seong Kang, Suwon-si (KR)

Correspondence Address: STANZIONE & KIM, LLP, 919 18TH STREET, N.W., SUITE 440, WASHINGTON, DC, 20006, US

(21) Appl. No.: 11/213,739

(22) Filed: Aug. 30, 2005

(30) Foreign Application Priority Data
Oct. 22, 2004 (KR) 2004-84758

(51) Int. Cl. B60H 1/00; G05D 23/00; G01K 13/00

(52) U.S. Cl. 236/94; 62/129; 165/11.1

(57) ABSTRACT

A device for a heat test includes a chamber having an accommodating part to accommodate an object to be tested, a temperature adjuster to adjust a temperature of the accommodating part of the chamber according to a plurality of temperature stages, a temperature detecting part to detect temperature distribution data representing temperature distributions of a plurality of parts of the object accommodated in the accommodating part adjusted at the plurality of temperature stages by the temperature adjuster, a controller receive and store the temperature distribution data detected according to the respective temperature stages by the temperature detecting part, and to calculate temperature differences from the temperatures distribution data between the temperature stages with respect to respective parts of the object, and an outputting part to display the temperature distribution data stored and calculated by the controller. The device and a method thereof provides the heat test capable of checking if the object has a problem or a possibility of causing the problem by visualizing the temperature distribution and variation of the object without causing damage on a circuit substrate of the object.

### CROSS-REFERENCE TO RELATED APPLICATIONS

This application claims the benefit under 35 U.S.C. §119 of Korean Patent Application No. 2004-84758, filed on Oct. 22, 2004, in the Korean Intellectual Property Office, the disclosure of which is incorporated herein by reference.

### BACKGROUND OF THE INVENTION

1. Field of the Invention

The present general inventive concept relates to a device and a method for a heat test, and more particularly, to a device and a method for a heat test to detect a temperature variation of chips on a circuit substrate.

2. Description of the Related Art

Generally, in electronic appliances is installed a circuit substrate for controlling an operation thereof. The circuit substrate comprises a plurality of semiconductor components. As environment in which the electronic appliances having the circuit substrate are used varies, the circuit substrate should have a certain level of durability. Various tests are conducted in designing the circuit substrate for durability thereof, which is called a reliability test.

One of the most important parts in the reliability test of the circuit substrate is to reflect results of the reliability test, such as a temperature distribution and variation, to a design stage of the circuit substrate. Particularly, such a test is essential in that a characteristic of the semiconductor components is changed according as a temperature of the circuit substrate is changed, thereby generating heat congestion in a certain part thereof.

Conventionally, the test of the circuit substrate is conducted by gradually heating the circuit substrate to predetermined temperatures and visually checking if the part thereof is damaged. That is, if the part thereof is damaged by heat, the part is determined to have the heat congestion and is redesigned.

However, the above test may check a problem of the substrate only when the part thereof is damaged, thereby causing damage to the substrate.

Also, since where the problem occurs cannot be forecast until the circuit substrate is damaged, it is difficult to design a circuit substrate which operates safely in view of heat congestion.

### SUMMARY OF THE INVENTION

In order to solve the above and/or other problems, the present general inventive concept provides a device and a method for a heat test capable of checking if an object has a problem or a possibility of causing the problem by visualizing a temperature distribution and variation of the object without damaging a circuit substrate.

Additional aspects and/or advantages of the present general inventive concept will be set forth in part in the description which follows and, in part, will be obvious from the description, or may be learned by practice of the present general inventive concept.

The foregoing and/or other aspects of the present general inventive concept may be achieved by providing a device for a heat test, the device comprising a chamber having an accommodating part to accommodate an object to be test, a temperature adjuster to adjust a temperature of the accommodating part of the chamber, a temperature detecting part to detect temperature distribution data representing temperature distributions of parts of the object accommodated in the accommodating part adjusted at a plurality of temperature stages by the temperature adjuster, a controller to receive and store data corresponding to the temperature distributions detected at each temperature stage by the temperature detecting part from the temperature distribution data, and to calculate a temperature difference between the temperature stages with respect to the respective parts of the object according to the temperature distributions, and an outputting part to display the data stored and calculated by the controller.

The temperature detecting part may comprise an infrared camera and a converter to convert a picture captured by the infrared camera into output data corresponding to the temperature distribution data.

The temperature detecting part may comprise a plurality of thermocoupler wires to be attached to corresponding ones of surfaces of the object accommodated in the accommodating part, a hybrid recorder to detect temperatures of the object attached with respective ones of the thermocoupler wires, and a converter to convert data received from the hybrid recorder into the output data.

The foregoing and/or other aspects of the present general inventive concept may also be achieved by providing a method for a heat test for an object comprising a circuit substrate, the method comprising driving the object according to a heating operation, respectively detecting data corresponding to temperature distributions of the object according to set temperatures, storing the temperature distributions of the object with respect to respective ones of the set temperatures, and calculating temperature differences between the set temperatures with respect to respective parts of the object, displaying a result stored and calculated, comparing the temperature differences and selecting at least one part of the object which has a greatest one of the temperature differences as a target to be examined.

The temperature distribution is detected by an infrared photograph of the object.

The temperature distribution is detected by a plurality of thermocoupler wires attached to a plurality of surfaces of the object.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view of a device for a heat test according to an embodiment of the present general inventive concept;

FIGS. 2A and 2B are pictures showing results of the device of FIG. 1;

FIG. 3 is a schematic view of the device for the heat test according to another embodiment of the present general inventive concept; and

FIG. 4 is a flow chart illustrating a method for a heat test according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout.

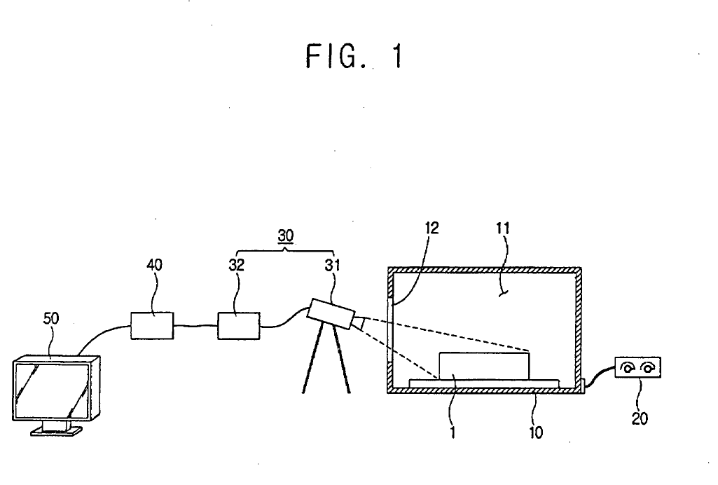

As shown in FIG. 1, a device for a heat test according to an embodiment of the present general inventive concept comprises a chamber 10 having an accommodating part 11 therein, a temperature adjuster 20 to adjust a temperature of the accommodating part 11 of the chamber 10 according to each of a plurality of temperature stages, a temperature detecting part 30 comprising an infrared camera 31 and a converter 32 to detect image data (or temperature distribution data) of an object 1 to be tested and located in the accommodating part 11, a controller 40 to store and calculate temperature distributions corresponding to the image data received from the converter 32, and a monitor 50 to display the temperature distribution stored in the controller 40 and a result of temperature differences calculated by the controller 40 with respect to the respective temperature stages.

Although the object 1 to be tested may or may not be operated by electricity, the object 1 is operated by electricity according to this embodiment of the present general inventive concept.

The chamber 10 is formed with a window 12 on a first side thereof to show an inside of the chamber 10. The infrared camera 31 photographs the inside of the chamber 10 through the window 12. Alternatively, the infrared camera 31 may be built in the chamber 10.

The temperature detecting part 30 photographs the object 1 to obtain a picture of the object 1 through the infrared camera 31, and converts the picture captured by the infrared camera 31 into the image data corresponding to the temperature distributions through the converter 32.

Meanwhile, the controller 40 stores the temperature distribution data representing the temperature distributions received from the converter 32, and calculates from the temperature distribution data temperature differences for each part of the object 1 with respect to the respective temperature stages. Further, the controller 40 lists or diagrammatizes the calculation results of each part of the object 1, or at least one part thereof, which has a greatest one of the temperature differences. The controller 40 may determine whether each part of the object 1 has a problem, such as damage, according to the temperature distributions of the object 1 with respect to the temperature stages, and generate a message about the problem.

The monitor 50 displays the temperature distribution stored in the controller 40 and the result of the temperature differences calculated by the controller 40 with respect to the temperature stages. Alternatively, the monitor 50 may be replaced with a printer, a plotter, etc. In this case, the controller 40 is required to create data for each displaying part. The controller 40 may determine whether each part of the object 1 has a problem, such as damage, according to the temperature distributions of the object 1 with respect to the temperature stages, and generate a message about the problem. Accordingly, the monitor 50 may display the message or the printer may print the message.

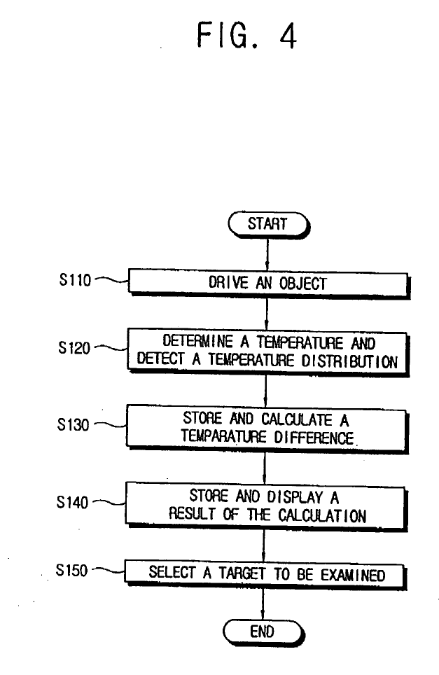

Referring to FIGS. 1 and 4, an operating process of the device for the heat test according to an embodiment of the present general inventive concept will be explained hereinafter.

First, the object 1 is positioned in the accommodating part 11 of the chamber 10 to be tested by detecting the temperature distribution, and the object 1 is driven at operation S110. The accommodating part 11 accommodating the object 1 is heated to a predetermined temperature by adjusting the temperature adjuster 20. When the object 1 is heated at the predetermined temperature, i. e., one of temperatures of the temperature stages, the infrared camera 31 photographs the object 1. In the same manner, the infrared camera 31 photographs the object 1 at respective temperature stages, where the temperature of the accommodating part 11 is raised one by one according to the temperature stages. The picture of the object 1 captured by the infrared camera 31 is converted into the image data (or temperature distribution data) representing the temperature distributions through the converter 32, so that the temperature distribution is detected at operation S120. Also, the controller 40 stores the temperature distribution data transmitted from the converter 32, and calculates the temperature differences of respective parts of the object 1 with respect to the temperature stages by calculating differences among the temperature distribution data stored at each temperature stage at operation S130. Then, the controller 40 lists or diagrammatizes the temperature differences according to the respective temperature stages for each part of the object 1, or at least one part thereof, which shows the greatest one of the temperature differences.

The monitor 50 displays the data stored in and calculated by the controller 40 at operation S140. Finally, the part having the greatest temperature difference is selected as a part possibly causing a problem and as a target to be examined at operation S150. The target may be automatically selected by the controller 40 according to the calculation results or directly by a user according to the results displayed on the monitor 50.

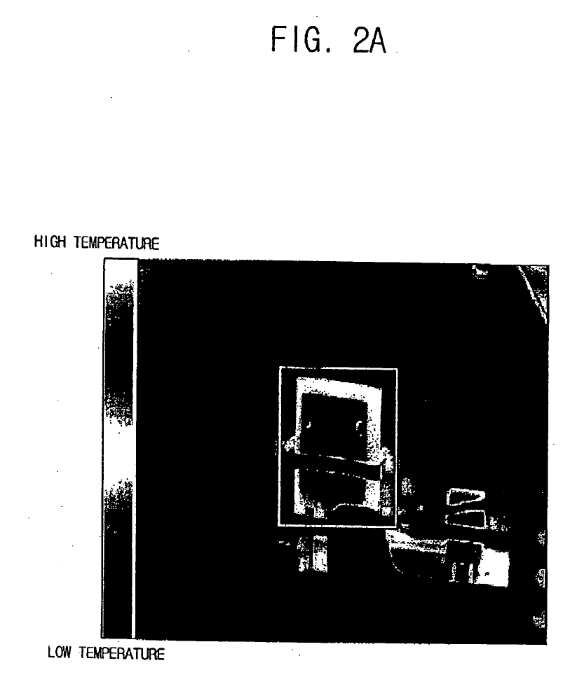

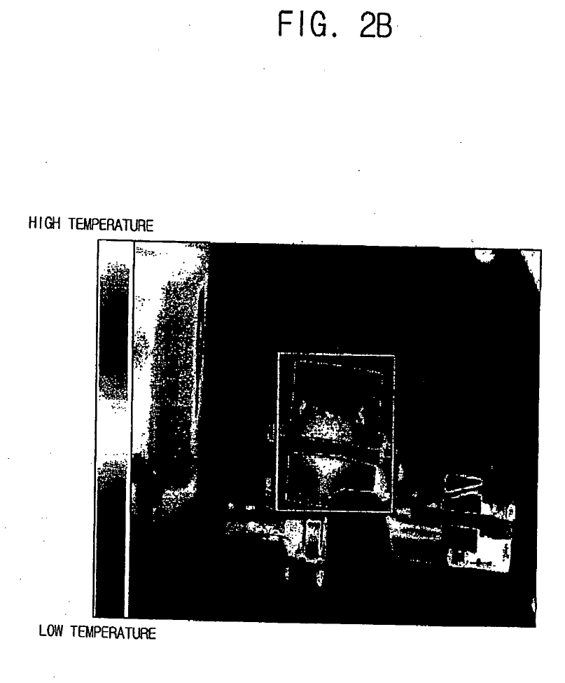

FIGS. 2A and 2B illustrate a part of the temperature distribution of the circuit substrate captured by the infrared camera 31 and displayed to the monitor 50. FIG. 2A shows the temperature distribution photographed at a normal temperature (25° C.), and FIG. 2B shows the temperature distribution photographed at a high temperature (65° C.). The normal and high temperatures are one of the temperature stages. In FIGS. 2A and 2B is provided a color distribution chart as a reference for the temperature distribution, which is shaped like a bar and vertically formed on the left of FIGS. 2A and 2B. In FIG. 2A and 2B, the circuit component in a rectangular window is heated to a higher temperature than other components when the temperature of the accommodating part 11 is set to 65° C. Accordingly, the circuit component in the rectangular window may be damaged due to heat congestion, and selected as the target for the redesign.

The circuit substrate is described as an example of the object 1, however, the object 1 is not limited thereto.

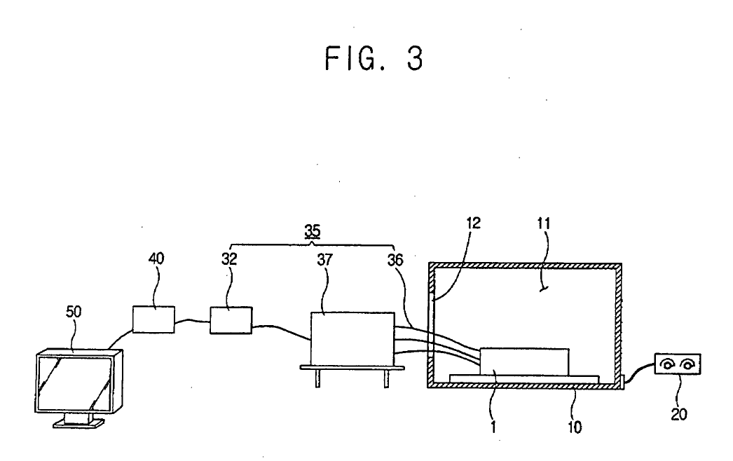

FIG. 3 is a schematic view of a device for a heat test according to an embodiment of the present general inventive concept. As shown in FIG. 3, a temperature detecting part 35 comprises a plurality of thermocoupler wires 36, a hybrid recorder 37 and a converter 32.

The plurality of thermocoupler wires 36 are attached to surfaces of parts of an object 1 to detect temperatures thereof, respectively. Also, the hybrid recorder 37 detects the temperatures (or surface temperatures) of the object 1 at the parts attached with corresponding ones of the thermocoupler wires 37, converts the detected temperatures of the parts into data (or temperature distribution data) by the converter 32, and sends the data to a controller 40. The controller 40 may determine whether the respective parts of the object 1 are defective or damaged, or have a problem according to the temperature distributions.

As shown in the embodiments of the present general inventive concept, the temperature distribution and variation of the surface of the component of the object 1, which may be a semiconductor component of the circuit substrate, possibly causing a problem are detected, listed, and graphed through a monitor 50 or other outputting parts.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A device for a heat test of an object, comprising:
a chamber having an accommodating part to accommodate an object to be tested;
a temperature adjuster to adjust a temperature of the accommodating part of the chamber;
a temperature detecting part to detect temperature distribution data corresponding to temperature distributions of a plurality of parts of the object accommodated in the accommodating part adjusted at a plurality of temperature stages by the temperature adjuster;
a controller to receive the temperature distribution data detected at the respective temperature stages by the temperature detecting part, and to calculate temperature differences from the temperature distribution data between the temperature stages with respect to the respective parts of the object; and
an outputting part to output data stored and calculated by the controller.

2. The device according to claim 1, wherein the temperature detecting part comprises:
an infrared camera to capture a picture of the object; and
a converter to convert the picture captured by the infrared camera into the temperature distribution data representing the temperature distributions.

3. The device according to claim 1, wherein the temperature detecting part comprises:
a plurality of thermocoupler wires to be attached to surfaces of a plurality of parts of the object accommodated to the accommodating part;
a hybrid recorder to detect data representing temperatures of the object through the respective thermocoupler wires; and
a converter to convert the data received from the hybrid recorder into the temperature distribution data.

4. The device according to claim 1, wherein the controller compares the temperature differences to obtain one temperature difference higher than other temperature differences among the calculated temperature differences such that at least one of the parts of the object, which has the one temperature difference, is selected as a target to be examined.

5. The device according to claim 1, wherein the temperature adjuster controls a temperature of the object so as to obtain the temperature distribution data from the object.

6. The device according to claim 1, wherein:
the temperature stages comprise first and second temperatures;
the plurality of parts of the object comprise first and second parts;
the temperature distribution data comprises first and second data of first and second parts according to the first and second temperatures, respectively;
the temperature differences comprise first and second temperature differences of the first and second parts, respectively; and
the controller calculates the first temperature difference between the first and second data of the first part of the object according to the first and second temperature stages, and also calculates the second temperature difference between the first and second data of the second part of the object according to the first and second temperature stages.

7. The device according to claim 6, wherein the controller selects one of the first and second temperature differences to select at least one of the first and second parts of the object as a target to be examined due to a defect on the at least one of the first and second parts of the object.

8. The device according to claim 1, wherein the object comprises first and second parts, and the controller calculates first temperature differences from the temperature distribution data between the temperature stages with respect to the first part of the object, calculates second temperature differences from the temperature distribution data between the temperature stages with respect to the second part of the object, and selects one of the first and second parts of the object as a target to be tested due to a defect on the one of the first and second parts of the object, according to the first and second temperature differences.

9. The device according to claim 1, wherein the outputting part comprises:
one of a monitor, a printer, and a plotter.

10. The device according to claim 1, wherein the temperature detecting part captures a picture of the object and converts the picture captured by the infrared camera into the temperature distribution data representing the temperature distributions.

11. The device according to claim 1, wherein the temperature detecting part comprises a plurality of thermocoupler wires to be attached to surfaces of a plurality of parts of the object accommodated to the accommodating part, detects data representing temperatures of the object through the respective thermocoupler wires, and converts the detected data into the temperature distribution data.

12. A method for a heat test for of an object comprising a circuit substrate, the method comprising:
driving an object having a plurality of parts according to a plurality of temperatures; detecting temperature distribution of the object according to the respective temperatures;
storing the temperature distribution of the respective temperatures, and calculating temperature differences between the temperatures with respect to the respective parts of the object;
displaying at least one of the stored temperatures distribution and the calculated temperature difference; and
comparing the temperature differences to obtain one temperature difference higher than other temperature differences to select at least one of the parts of the object, which has the one temperature difference, as a target to be examined.

13. The method according to claim 12, wherein the temperature distribution is detected by an infrared photograph of the object.

14. The method according to claim 13, wherein the temperature distribution is detected by a plurality of thermocoupler wires attached to surfaces of the object.

15. A method for a heat test for of an object comprising a circuit substrate, the method comprising:
providing an object having a plurality of parts to be tested in an accommodating part of a chamber;
adjusting a temperature of the object according to a plurality of temperature stages;
detecting temperature distribution data corresponding to temperature distributions of the respective parts of the object with respect to the respective temperature stages by the temperature adjuster;
calculating temperature differences from the temperature distribution data detected at the respective temperature stages the respective parts of the object; and
outputting at least one of the temperature distribution data and the temperature differences.

16. The method according to claim 15, further comprising:
comparing the temperature differences to obtain one temperature difference higher than other temperature differences among the calculated temperature differences such that at least one of the parts of the object, which has the one temperature difference, is selected as a target to be examined.

17. The method according to claim 15, wherein the adjusting of the temperature of the object comprises:
supplying the object with electricity to heat the object so as to obtain the temperature distribution data from the object.

18. The method according to claim 15, wherein the adjusting of the temperature of the object comprises:
adjusting a temperature of the accommodating part of the chamber according to the plurality of temperature stages to heat the object.

19. The method according to claim 15, wherein the detecting of the temperature distribution data comprises:
capturing a picture of the object and converts the picture into the temperature distribution data representing the temperature distributions.

20. The device according to claim 15, wherein the detecting of the temperature distribution data comprises:
providing a plurality of thermocoupler wires to be attached to surfaces of a plurality of parts of the object accommodated to the accommodating part; and
detecting data representing temperatures of the object through the respective thermocoupler wires, and converts the detected data into the temperature distribution data.
